(19) United States
(12) Patent Application Publication
(10) Pub. No.: US 2006/0242883 A1
(43) Pub. Date: Nov. 2, 2006

(54) Decoy weight

(76) Inventor: John Tilby, Sandy, UT (US)

Correspondence Address: John Tilby, 9352 South 670 West, Sandy, UT, 84070, US

(21) Appl. No.: 11/115,760

(22) Filed: Apr. 28, 2005

(51) Int. Cl. A01M 31/06

(52) U.S. Cl. 43/3

(57) ABSTRACT

An anchor for use with a waterfowl decoy having a body and including an anchor cord with one end affixed to the bottom of the body and an opposite end affixed to a pull ring; the pull ring having an elastic cord passed therethrough and the opposite ends of the elastic cord secured to opposite ends of a weight.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO MICROFICHE APPENDIX

Not Applicable.

### BACKGROUND OF THE INVENTION

1. Field of the Invention

This invention relates to decoy weights and is particularly related to weights that are suspended beneath the keel of a waterfowl decoy when the decoy is placed in a body of water for the purpose of attracting birds.

It has long been common for hunters to use decoys to attract game. Particularly, it has long been known to provide waterfowl decoys that resemble a particular bird that is being hunted and to place such decoys on the waters of lakes, reservoirs, streams, or the like, as a means for attracting live waterfowl to the area.

Frequently, the waterfowl decoys used, include a body and a head corresponding to the general shape of the waterfowl to be attracted. Such decoys can be made of a variety of materials. Wooden carved figures have been used for a very long period of time, but more recently, plastic molded figures have come more into favor. This may be because of costs of production, or the ability to obtain a repetitive shaped decoy. In any event, the decoys used frequently have a keel member extending centrally along the bottom of the decoy and projecting downwardly from the decoy when the decoy is placed in water. The keel, of course, keeps the decoy floating in a proper, upright position. However, it is still possible for the decoy to be carried away with water movement and to become difficult to locate and recover, particularly if the water has a current flow and/or if the prevailing winds move the decoy. To prevent such unwanted decoy movement, there have been a number of anchor systems proposed for use with waterfowl decoys. In general, such anchor systems include a tether line having one end attached to the keel of the waterfowl decoy and an opposite end attached to a weight that will rest on a bottom surface beneath the decoy and the water, or that may even just be suspended into the water from beneath the decoy. The weight system used is intended to further stabilize the waterfowl decoy and to prevent it from moving from an area where it has been positioned by a hunter and from becoming difficult to recover or from becoming lost.

2. Prior Art

The need for weights to be suspended from waterfowl decoys has long been recognized. Typical of the known decoy anchors are those shown in U.S. Pat. Nos. 2,747,315; 4,757,630; 5,899,014; and 6,857,216, each of which discloses a weight and means for securing the weight to be suspended below and attached to the keel of a waterfowl decoy.

U.S. Pat. No. 2,747,315, discloses an anchor system for use with decoys wherein a weight made from lead, or other suitable material, is formed on the ends of a flexible, stainless steel cable that is formed into a loop. The loop has an anchor line tied thereto. A bead slides on the cable length to change the size of the loop formed by the cable. In use, one end of the anchor line is secured to the bottom of a waterfowl decoy and the other end is attached to the loop formed by the stainless steel cable. The bead is positioned to set the size of the loop formed by the stainless steel cable and the weight is allowed to be suspended from the anchor line and the stainless steel cable to stabilize the floating decoy. The anchor weight may sit on the bottom of the lake, stream, or other area in which the decoy anchor is used.

U.S. Pat. No. 4,757,630 discloses a much more complex waterfowl decoy anchor. As disclosed, a winch assembly is affixed to the waterfowl decoy between a keel and the bottom of the decoy. The winch assembly extends forwardly of the keel and provides means for lowering and raising a teardrop shaped weight to engage the bottom of the lake, reservoir, river, or other body of water in which the waterfowl decoy may be used. Such a system is necessarily costly, bulky, and does not allow for easy storage of the waterfowl decoy and the anchor system used.

U.S. Pat. No. 5,899,014 discloses a waterfowl decoy having a centrally positioned elongate bottom keel with holes through a front and rear ends of the keel. One or more lengths of cord form a tether line, one end of which is secured to the keel using flexible expansion wings to prevent withdrawal of the end of the tether line from the holes through the keel. Another end of the tether line, is passed through a loop attached to an anchor weight and is held in place by an eyelet and hook arrangement, or by the same type of flexible expansion members used on the end of the tether line connected to the keel. An additional cord can be connected to the hole at the rear of the keel and can be connected intermediate the length of the cord or interconnected cords forming the tether line. When the anchor system is to be stowed, the tether line is wrapped around the bottom of the decoy and above the keel and then is secured in place using the hook or the expansion member on the end of the cord that is secured to the weight to connect to the weight to the wrapped tether line. When the tether line has been stowed beneath the waterfowl decoy, the weight, which is disclosed as being of teardrop configuration, is suspended from the tether line alongside the keel.

U.S. Pat. No. 6,857,216, discloses a decoy anchor wherein a cord has one end tied to an eyelet opening formed in a lengthwise extending keel positioned beneath a waterfowl decoy. The other end of the cord is tied to a D-ring connected to one end of an elastic cord or tubing, the other end of which passes into an anchor ball to be secured in place. The connecting cord and anchor is wrapped around the keel for storage.

The anchor weights disclosed in the aforementioned U.S. patents, are each made from materials commonly used in manufacturing sinkers to be attached to fishing lines of fishermen. In addition, the anchor weights of the foregoing U.S. patents, like the sinkers used with fishing tackle are shaped to be easily pulled through and over rocks and debris with a minimum amount of snagging.

U.S. Pat. No. 77,628 discloses a fishing line sink that is elongate and flat and that also functions as a swivel when used with fishing tackle. However, the sinker interconnects a line connected to a fishing pole and a line attached to a hook.

### BRIEF SUMMARY OF THE INVENTION

### OBJECTS OF THE INVENTION

Principal objects of the present invention are to provide a waterfowl decoy weight that is relatively inexpensive and easy to use.

Other objects are to provide an anchor weight for use with waterfowl decoys that has a weight that is resistant to becoming snagged on rocks and debris at the bottom of a body of water on which the decoy is floated and that will allow decoy movement even if it becomes snagged.

Still another object is to provide an anchor weight for a waterfowl decoy that will stow flat against a keel at the bottom of the decoy so that collected decoys do not become entangled.

Yet other objects are to provide an anchor weight for a waterfowl decoy that can be easily positioned against and released from the keel of a decoy.

### FEATURES OF THE INVENTION

Principal features of the invention include a decoy weight to be secured by an anchor line to a bottom keel spaced from, but secured to a waterfowl decoy having the usual head and body structure common to such waterfowl decoys.

The decoy weight includes an anchor line having one end tied or otherwise connected to the keel of the decoy. The other end of the anchor line is tied to a pull ring.

An elastic cord passes through the pull ring and the ends of the elastic cord are respectively secured to opposite ends of a flat, elongate weight.

Additional objects and features of the invention will become apparent to persons skilled in the art to which the invention pertains from the following detailed description and claims.

### BRIEF DESCRIPTION OF THE FIGURES OF THE INVENTION

In the Drawings

FIG. 1 is a perspective view of a waterfowl decoy floating on water and having an anchor secured to and suspended beneath a keel of the decoy;

FIG. 2, a perspective view of the waterfowl decoy with the anchor cord tied to the keel of the decoy and wrapped around the connector between keel and decoy bottom;

FIG. 3, a bottom plain view of the waterfowl decoy and showing the pull ring being pulled to position the elastic cord around the connector, between the decoy body and the keel;

FIG. 4, a view like that of FIG. 3, showing the pull ring being pulled to position the weight alongside the keel; and

FIG. 5, a view like that of FIG. 4, after the ring has been released.

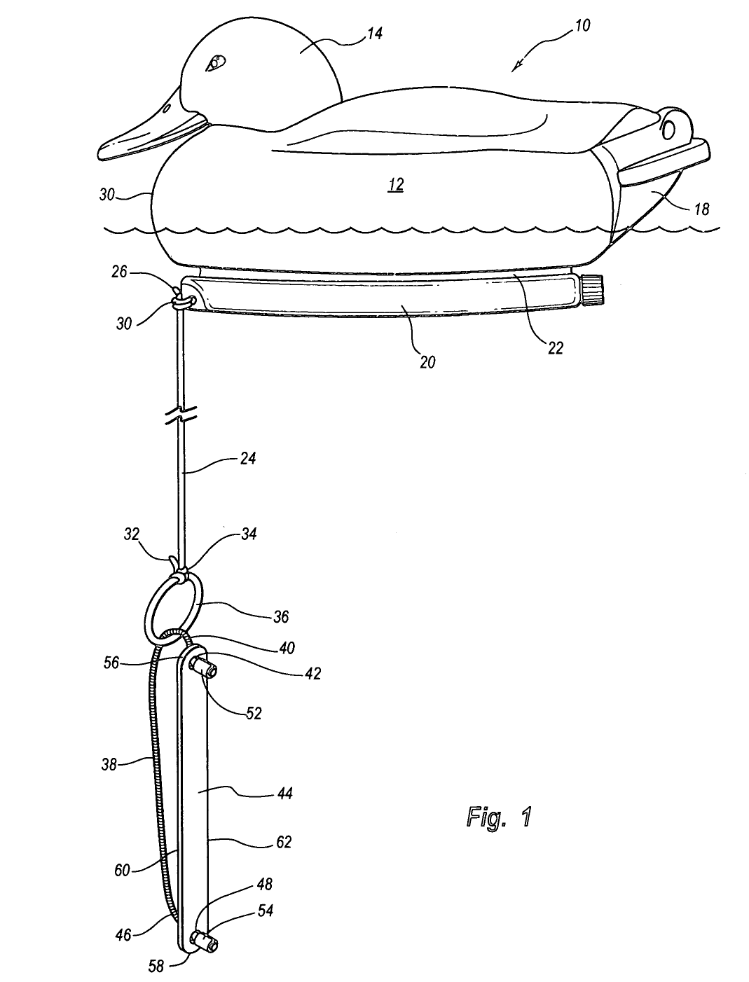

### DETAILED DESCRIPTION

Referring Now the Drawings

In the illustrated preferred embodiment of a waterfowl decoy 10, having a body 12, with a head 14 on the top of and at a front end 16 of the body. Decoy 10 has a rear end 18.

A keel 20 is fixed to and extends the length of the bottom of body 12. The keel is connected to the body 12 by a connector strip 22, having a width and length slightly less than the width and length of the keel.

An anchor line 24 has one end 26 inserted through a hole 28 through the front of keel 20. The other end 32 of anchor line 24 is tied with knot 34 to a pull ring 36.

An elastic cord 38 extends through ring 36 and has one end 40 inserted through a hole 42 in one end of an elongate, flat weight 44. The opposite end 46 of elastic cord 36 is inserted through a hole 48 formed through the other end 50 of weight 44.

Metal bands 52 and 54 are respectively crimped onto the ends 40 and 46 of elastic cord 38. The bands 52 and 54 are too large to pass through 42 and 48 and hold the elastic cord 38 in place.

Weight 44 is a flat strip of lead, or other suitable material, with rounded ends 56 and 58. Side edges 60 and 62 of weight 44 are narrow and the weight 44 preferably has a thickness to width ratio of about 1:5-10. It has been found that such a thickness to width ratio, together with the rounded ends of weight 44 allows the weight to engage in travel on the bottom of a body of water without frequent snagging.

It has also been found that if the anchor 44 does snag, the elastic connection afforded by elastic cord 38 will still allow the decoy to move with wave action or current of the water. The waterfowl decoy 10 will therefore give an appearance of a floating bird, even if the anchor is snagged.

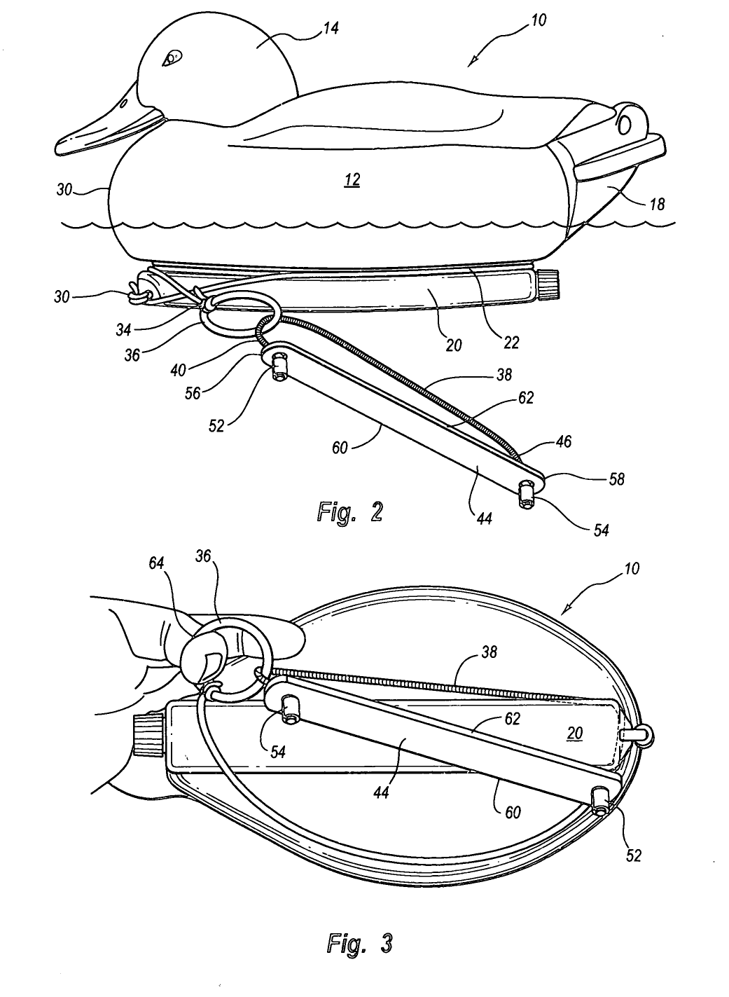

After use, the waterfowl decoy 10 is retrieved from the water surface and is stowed for future use. When the decoy is placed in condition to be stowed, the anchor line 38 is wrapped around the connector 22, as shown best in FIG. 2.

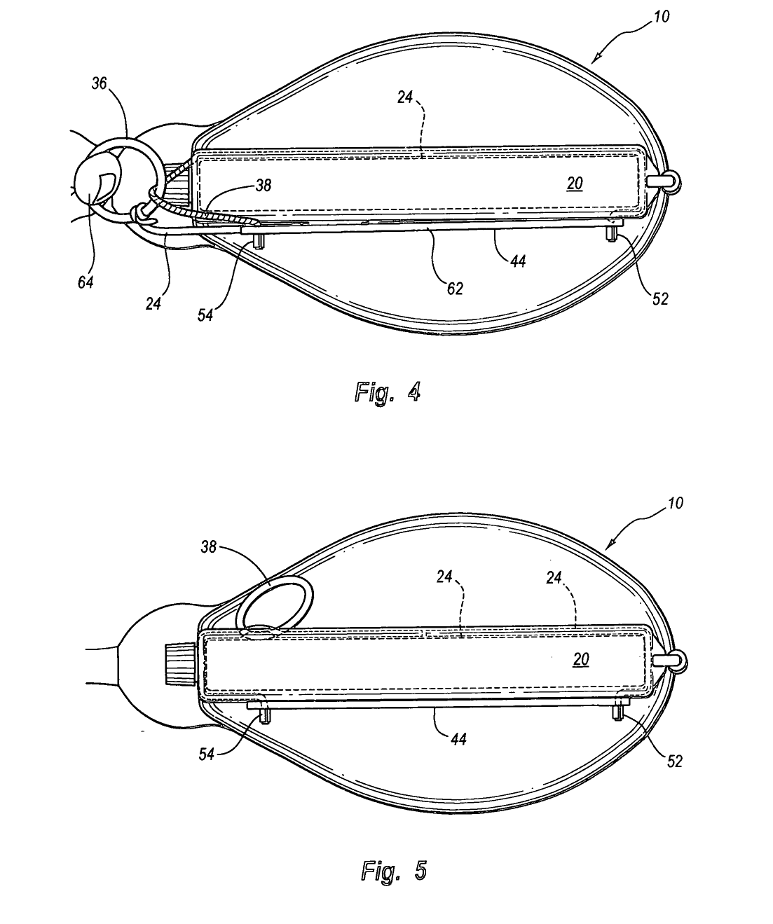

Once the anchor line 38 has been wrapped around connector 22, the user inserts a finger 64 through ring 36 to stretch the resilient cord 38 over the keel 20 and the connector 22 as shown in FIGS. 3 and 4. Weight 44 then lays flat against keel 20. When ring 36 is released the ring is held against keel 20, as shown in FIG. 5.

To release the stowed weight 44 it is only necessary for the user to insert a finger through ring 36 and to pull stretch the elastic cord 38 to pass over keel 22 and then to unwrap the anchor line 24.

While the anchor of the present invention is particularly adapted for use with a waterfowl decoy having a keel attached to a decoy body with a connector strip, it will be apparent that the anchor can be used with any decoy body with a bottom to which the anchor line may be attached and a structure around which the elastic cord may be stretched and against which the weight will rest.

Although a preferred embodiment of my invention has been herein described, it is to be understood that the present disclosure is by way of example and that variations are possible without departing from the subject matter coming within the scope of the following claims, which subject matter I regard as my invention.

I claim:

1. A waterfowl decoy anchor comprising
a flexible anchor line having one end to be secured beneath a decoy body and an opposite end;
an elongate weight; and
resilient means connecting the opposite end of said anchor line to said weight.

2. A waterfowl decoy anchor as in claim 1, further including
a pull ring interconnecting the anchor line and the resilient means.

3. A waterfowl decoy anchor as in claim 1, wherein
the resilient means comprises an elastic cord having opposite ends spaced apart and respectively connected to opposite ends of the weight.

4. A waterfowl decoy anchor as in claim 3, further including
a pull ring;
said resilient cord passing through said ring; and
means connecting opposite ends of the resilient cord respectively to opposite ends of said weight.

5. A waterfowl decoy anchor as in claim 4, wherein
the weight is an elongate, flat metal strip.

6. A waterfowl decoy anchor as in claim 5, wherein
the weight has rounded ends.

7. A waterfowl decoy anchor comprising
an anchor line having one end to be attached to the bottom of a waterfowl decoy and an opposite end connected to a pull ring;
an elastic cord passed through said pull ring;
means securing one end of said elastic cord to one end of said weight; and
means securing the opposite end of said elastic cord to an opposite end of said weight.

8. A waterfowl decoy anchor as in claim 7, wherein
the weight has rounded ends.

9. A waterfowl decoy having a body with a front end, a rear end and a head formed on the top of the body at the front end of the body;
a keel fixed to and projecting away from a bottom of the body;
a connector member interconnecting the bottom of said decoy and the keel, said keel being wider and longer than said connector member;
a flexible anchor line having one end attached to said keel;
a pull ring secured to an opposite end of said anchor line;
an elastic cord passed through said pull ring;
an elongate flat weight; and
means respectively securing the ends of the elastic cord to opposite ends of the weight; and wherein
the opposite ends of said elongate, flat weight are rounded.
